(19) United States
(12) Patent Application Publication
(10) Pub. No.: US 2026/0050797 A1
(43) Pub. Date: Feb. 19, 2026

(54) INFORMATION PROCESSING SYSTEM, INFORMATION PROCESSING DEVICE, AND INFORMATION PROCESSING METHOD

(71) Applicant: NEC Corporation, Tokyo (JP)

(72) Inventor: Junki MORI, Tokyo (JP)

(73) Assignee: NEC Corporation, Tokyo (JP)

(21) Appl. No.: 19/283,682

(22) Filed: Jul. 29, 2025

(30) Foreign Application Priority Data
Aug. 15, 2024 (JP) 2024-135607

(51) Int. Cl. G06N 3/098

(52) U.S. Cl. CPC G06N 3/098

(57) ABSTRACT

A first information processing device includes a first acquisition unit acquiring a feature representing a target and a result obtained for the target, a first prediction unit predicting a status of intervention likely to have affected the result based on the feature, and a first prediction model training unit training a prediction model for predicting an effect of the intervention by federated learning performed by the first information processing device and a second information processing device based on the feature, the result, and the status of the intervention. The second information processing device includes a second acquisition unit acquiring the feature and the status of the intervention, a second prediction unit predicting the result based on the feature, and a second prediction model training unit training the prediction model by the federated learning based on the feature, the result, and the status of intervention.

This application is based upon and claims the benefit of priority from Japanese Patent Application No. 2024-135607, filed on Aug. 15, 2024, the disclosure of which is incorporated herein in its entirety by reference.

### TECHNICAL FIELD

The present disclosure relates to an information processing system, an information processing device, and an information processing method.

### BACKGROUND ART

Techniques for predicting an effect of intervention performed to affect a result related to a target have been known. For example, WO 2021/235200 A1 describes a technique for predicting an increase (an example of the effect of intervention) in a purchase rate of a product caused by intervention of product advertisement display based on a feature of a user (an example of the target). According to the technique, a prediction model for predicting the effect of the advertisement display based on the feature of the user is generated using training data in which the feature of the user, the presence or absence of the advertisement display, and the presence or absence of the product purchase are associated with each other.

### SUMMARY

Here, there is a case where an organization (for example, an advertisement distributor who knows the presence or absence of advertisement display for the user) that knows a status of intervention related to the target is different from an organization (for example, an advertiser that knows whether the user has purchased the product) that knows a result obtained for the target. There is a possibility that it is difficult to exchange information between such different organizations so as to be able to associate the status of intervention and the result. In the technique described in WO 2021/235200 A1, there is a problem that an effect of the intervention cannot be predicted from a feature representing a target when a status of the intervention related to the target and a result obtained for the target cannot be acquired in association with each other.

The present disclosure has been made in view of the above problem, and an exemplary object thereof is to provide a technique capable of predicting an effect of intervention from a feature representing a target when a status of the intervention related to the target and a result obtained for the target cannot be acquired in association with each other.

An information processing system according to an exemplary aspect of the present disclosure includes a first information processing device and a second information processing device, wherein the first information processing device includes one or more memories storing instructions, and one or more processors configured to execute the instructions to acquire a feature representing a target and a result obtained for the target, predict a status of intervention that is likely to have affected the result based on the feature, and train a prediction model for predicting an effect of the intervention by federated learning performed by the first information processing device and the second information processing device based on the feature, the result, and the status of the intervention, and the second information processing device includes one or more memories storing instructions, and one or more processors configured to execute the instructions to acquire the feature and the status of the intervention, predict the result based on the feature, and train the prediction model by the federated learning based on the feature, the result, and the status of the intervention.

An information processing device according to an exemplary aspect of the present disclosure includes one or more memories storing instructions, and one or more processors configured to execute the instructions to acquire a feature representing a target and a result obtained for the target, predict a status of intervention that is likely to have affected the result based on the feature, and train a prediction model for predicting an effect of the intervention by federated learning performed by another information processing device capable of acquiring a status of the intervention and the information processing device based on the feature, the result, and the status of the intervention.

An information processing device according to an exemplary aspect of the present disclosure includes one or more memories storing instructions, and one or more processors configured to execute the instructions to acquire a feature representing a target and a status of intervention that is likely to have affected a result obtained for the target, predict the result based on the feature, and train a prediction model for predicting an effect of the intervention by federated learning performed by another information processing device capable of acquiring the result and the information processing device based on the feature, the result, and the status of the intervention.

An information processing method according to an exemplary aspect of the present disclosure is an information processing method executed by an information processing system including a first information processing device and a second information processing device, and includes acquiring, by at least one processor included in the first information processing device, a feature representing a target and a result obtained for the target, predicting, by the at least one processor included in the first information processing device, a status of intervention that is likely to have affected the result based on the feature, training, by the at least one processor included in the first information processing device, a prediction model for predicting an effect of the intervention by federated learning performed by the first information processing device and the second information processing device based on the feature, the result, and the status of the intervention, acquiring, by at least one processor included in the second information processing device, the feature and the status of the intervention, predicting, by the at least one processor included in the second information processing device, the result based on the feature, and training, by the at least one processor included in the second information processing device, the prediction model by the federated learning based on the feature, the result, and the status of the intervention.

An information processing method according to an exemplary aspect of the present disclosure, executed by a computer, includes acquiring, by at least one processor included in an information processing device, a feature representing a target and a result obtained for the target, predicting, by the at least one processor, a status of intervention that is likely to have affected the result based on the feature, and training, by the at least one processor, a prediction model for predicting an effect of the intervention by federated learning performed by another information processing device capable of acquiring the status of the intervention and the information processing device based on the feature, the result, and the status of the intervention.

An information processing method according to an exemplary aspect of the present disclosure, executed by a computer, includes acquiring, by at least one processor included in an information processing device, a feature representing a target and a status of intervention that is likely to have affected a result obtained for the target, predicting, by the at least one processor, the result based on the feature, and training, by the at least one processor, a prediction model for predicting an effect of the intervention by federated learning performed by another information processing device capable of acquiring the result and the information processing device based on the feature, the result, and the status of the intervention.

According to an exemplary aspect of the present disclosure, there is an exemplary effect that it is possible to provide the technique capable of predicting the effect of the intervention from the feature representing the target when the status of the intervention related to the target and the result obtained for the target cannot be acquired in association with each other.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing system according to the present disclosure;

FIG. 2 is a flowchart illustrating a flow of an information processing method according to the present disclosure;

FIG. 3 is a block diagram illustrating a configuration of an information processing device according to the present disclosure;

FIG. 4 is a flowchart illustrating a flow of an information processing method according to the present disclosure;

FIG. 5 is a block diagram illustrating a configuration of an information processing device according to the present disclosure;

FIG. 6 is a flowchart illustrating a flow of an information processing method according to the present disclosure;

FIG. 7 is a view schematically illustrating an outline of an information processing system according to the present disclosure;

FIG. 8 is a block diagram illustrating a configuration of the information processing system according to the present disclosure;

FIG. 9 is a flowchart illustrating a flow of an information processing method according to the present disclosure;

FIG. 10 is a view schematically illustrating each model according to a modified example of the present disclosure;

FIG. 11 is a flowchart illustrating a flow of an information processing method according to the modified example of the present disclosure;

FIG. 12 is a view schematically illustrating an application example using the information processing system according to the present disclosure; and

FIG. 13 is a block diagram illustrating a hardware configuration of a computer that functions as devices according to the present disclosure.

### EXAMPLE EMBODIMENT

Hereinafter, example embodiments of the present disclosure will be described. However, the present disclosure is not limited to the example embodiments described below, and various modifications can be made within the scope described in the claims. For example, example embodiments obtained by appropriately combining techniques (some or all of things or methods) adopted in the following example embodiments can also be included in the scope of the present disclosure. Example embodiments obtained by appropriately omitting some of the techniques adopted in the following example embodiments can also be included in the scope of the present disclosure. Effects mentioned in the following example embodiments are examples of effects expected in the example embodiments, and do not define the extension of the present disclosure. That is, example embodiments that do not achieve the effects mentioned in the following example embodiments can also be included in the scope of the present disclosure.

### First Example Embodiment

A first example embodiment that is an example of an example embodiment of the present disclosure will be described in detail with reference to the drawings. The present example embodiment is a basic form of each example embodiment described below. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in the drawings referred to for description of the present example embodiment can also be adopted in the other example embodiments included in the present disclosure within a range in which no particular technical problem occurs.

### (Outline of Information Processing System 1)

An information processing system 1 is a system that generates, by cooperation of a plurality of information processing devices, a prediction model for predicting an effect of intervention that is likely to affect a result obtained for a target based on a feature representing the target. Hereinafter, a method of generating a prediction model by cooperation of a plurality of information processing devices will be described as federated learning.

Here, a “target” is a target for which an effect of intervention needs to be predicted, and examples thereof include, but are not limited to, a visitor of a website and a patient in a medical institution. A “feature representing a target” is information representing the target, and examples thereof include, but are not limited to, age, gender, preference, product purchase history, treatment history, and anamnesis. “Intervention” is a process or an action performed to affect a result obtained for a target, and examples thereof include, but are not limited to, “advertisement display” and “treatment”. An “effect of intervention” is a degree of improvement of a result obtained for a target due to the influence of the intervention, and examples thereof include, but are not limited to, an increase in a purchase rate caused by advertisement display, an effect on a symptom caused by treatment, and the like.

In order to generate a prediction model for predicting an effect of intervention, for example, (i) a feature representing a target, (ii) a result obtained for the target, and (iii) a status of intervention that is likely to have affected the result are necessary as training data. A “status of intervention” may be, for example, the presence or absence of the intervention itself, a type of the intervention when being executed, a degree of the intervention, or the like, but is not limited thereto. Hereinafter, a “result obtained for a target” may be described as a “result related to a target” or simply as a “result”. In addition, a “status of intervention that is likely to have affected the result” may be described as a “status of intervention related to a target” or simply as a “status of intervention”.

Here, there is a case where an information processing device capable of acquiring a “result” is different from an information processing device capable of acquiring a “status of intervention”. In such a case, the information processing system 1 can create the above-described prediction model without requiring mutual disclosure of the result and the status of the intervention acquired by the respective information processing devices.

### (Configuration of Information Processing System 1)

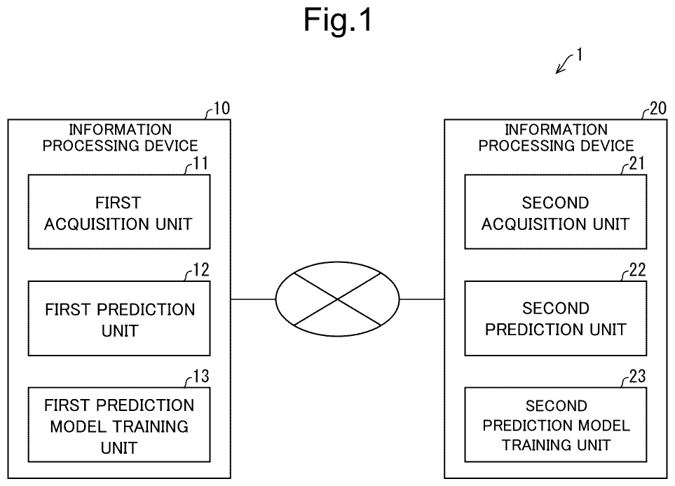

A configuration of the information processing system 1 will be described with reference to FIG. 1. FIG. 1 is a block diagram illustrating the configuration of the information processing system 1.

As illustrated in FIG. 1, the information processing system 1 includes an information processing device 10 and an information processing device 20. The information processing devices 10 and 20 are communicably connected via a network.

Each of the information processing devices 10 and 20 has at least a function of training a local model as a plurality of clients in federated learning. In addition, any one of the information processing devices 10 and 20 may further have a function of integrating a plurality of the local models as a server in the federated learning. In addition, the information processing devices 10 and 20 may be communicably connected to a device (not illustrated) that functions as the server in the federated learning. The number of the information processing devices 10 included in the information processing system 1 is not limited to one, and may be plural.

The number of the information processing devices 20 included in the information processing system 1 is not limited to one, and may be plural.

The information processing device 10 is an example of a first information processing device. The information processing device 10 is a device that can acquire a feature representing a target and a result related to the target, but cannot acquire a status of intervention that is likely to have affected the result.

The information processing device 10 includes a first acquisition unit 11, a first prediction unit 12, and a first prediction model training unit 13. The first acquisition unit 11 is an example of a configuration for implementing a first acquisition means. The first prediction unit 12 is an example of a configuration for implementing a first prediction means. The first prediction model training unit 13 is an example of a configuration for implementing a first prediction model training means.

The first acquisition unit 11 acquires a feature representing a target and a result obtained for the target.

Hereinafter, information acquired by the first acquisition unit 11 is described as first input information. The first input information includes a feature representing a target and a result obtained for the target. The first input information desirably includes a set of the feature and the result related to each of a plurality of the targets.

The first prediction unit 12 predicts a status of intervention that is likely to have affected a result related to a target based on a feature representing the target. Specifically, the first prediction unit 12 predicts a status of intervention related to each of the plurality of targets based on the feature representing the target included in the first input information. For example, the first prediction unit 12 may perform prediction using a model for predicting a status of intervention related to a target based on a feature representing the target.

The first prediction model training unit 13 trains a prediction model for predicting an effect of the intervention by the federated learning performed by the information processing devices 10 and 20 based on the feature, the result, and the status of the intervention. For example, the first prediction model training unit 13 may train, using the first input information and the predicted status of the intervention as training data, a first prediction model for predicting an effect of intervention related to a target based on a feature representing the target by machine learning with reference to an integrated model of the first prediction model and a second prediction model that has been trained by the information processing device 20. The first prediction model and the second prediction model are local models in the federated learning. For example, the information processing device 10 may use the trained first prediction model as a prediction model, or may use the integrated model of the trained first prediction model and the trained second prediction model as a prediction model.

The information processing device 20 is an example of a second information processing device. The information processing device 20 is a device that can acquire a feature representing a target and a status of intervention that is likely to have affected a result related to the target, but cannot acquire the result.

The information processing device 20 includes a second acquisition unit 21, a second prediction unit 22, and a second prediction model training unit 23. The second acquisition unit 21 is an example of a configuration for achieving a second acquisition means. The second prediction unit 22 is an example of a configuration for achieving a second prediction means. The second prediction model training unit 23 is an example of a configuration for achieving a second prediction model training means.

The second acquisition unit 21 acquires a feature representing a target and a status of intervention that is likely to have affected a result obtained for the target. Hereinafter, information acquired by the second acquisition unit 21 is described as second input information. The second input information includes a feature representing a target and a status of intervention that is likely to have affected a result obtained for the target. The second input information desirably includes a set of the feature and the status of the intervention regarding each of a plurality of the targets.

The second prediction unit 22 predicts a result related to a target based on a feature representing the target. Specifically, the second prediction unit 22 predicts a result related to each of the plurality of targets based on a feature representing the target included in the second input information. For example, the second prediction unit 22 may perform prediction using a model for predicting a result related to a target based on a feature representing the target.

The second prediction model training unit 23 trains a prediction model for predicting an effect of the intervention by the federated learning performed by the information processing devices 10 and 20 based on the feature, the result, and the status of the intervention. For example, the second prediction model training unit 23 may train, using the second input information and the predicted result as training data, the second prediction model for predicting an effect of intervention related to a target based on a feature representing the target by machine learning with reference to an integrated model of the second prediction model and the first prediction model that has been trained by the information processing device 10. As described above, the first prediction model and the second prediction model are local models in the federated learning.

For example, the information processing device 20 may use the trained second prediction model as a prediction model, or may use the integrated model of the trained first prediction model and the trained second prediction model as a prediction model.

### (Federated Learning)

Here, for example, federated learning is adopted as a technique in which the first prediction model training unit 13 and the second prediction model training unit 23 train prediction models. In other words, the first prediction model and the second prediction model are trained by the federated learning. An “integrated model” is called, for example, a global model in the federated learning. As described above, the first prediction model and the second prediction model are called, for example, local models in the federated learning. In other words, the first prediction model, the second prediction model, and the global model are trained as prediction models by the federated learning.

Targets of the federated learning may be the entire first prediction model and the entire second prediction model, or may be a part of the first prediction model and a part of the second prediction model. In a case where a part of the first prediction model and a part of the second prediction model are trained by the federated learning, the remaining part of the first prediction model may be locally trained by the information processing device 10 without using the federated learning. The remaining part of the second prediction model may be locally trained by the information processing device 20 without using the federated learning.

In the federated learning, (i) training the first prediction model by the information processing device 10 with reference to the global model and training the second prediction model by the information processing device 20 with reference to the global model, and (ii) integrating the trained first prediction model and the trained second prediction model to generate a new global model are repeated. The training data used for the training of the first prediction model and the training data used for the training of the second prediction model do not need to be disclosed between the information processing device 10 and the information processing device 20.

### (First Prediction Model)

The first prediction model is a local model trained by the information processing device 10 in order to obtain a model for predicting an effect of intervention related to a target based on a feature representing the target by the federated learning. The first prediction model may include, for example, a third prediction model for predicting a result in the case of presence of the intervention based on the feature, and a fourth prediction model for predicting a result in the case of absence of the intervention based on the feature. In this case, information obtained by subtracting an output of the fourth prediction model from an output of the third prediction model may be output from the first prediction model as the effect of the intervention.

In a case where a “status of intervention” includes only the presence or absence of the intervention, inputs of the third prediction model and the fourth prediction model may be only the “feature”. In a case where the “status of intervention” includes information, such as a type of the intervention or a degree of the intervention, other than the presence or absence of the intervention, the input of the third prediction model for predicting the result in the case of the presence of the intervention may include the status of the intervention in addition to the feature.

For example, the first prediction model training unit 13 classifies each of the sets of features and results included in the first input information into either the presence of the intervention or the absence of the intervention based on the status of the intervention predicted by the first prediction unit 12. As a result, the third prediction model is trained using a set of a feature and a result classified as the presence of the intervention as training data. In other words, the third prediction model is trained in such a way that the result in the case of the presence of the intervention is output when the feature is input. As described above, in the case where the status of the intervention includes information other than the presence or absence of the intervention, the third prediction model may be trained in such a way that the result in the case of the presence of the intervention is output when the feature and the status of the intervention are input. The fourth prediction model is trained using a set of a feature and a result classified as the absence of the intervention as training data. In other words, the fourth prediction model is trained in such a way that the result in the case of the absence of the intervention is output when the feature is input.

In addition, the first prediction model is trained with reference to the global model. “Being trained with reference to the global model” is, for example, being trained using parameters of the global model as initial parameters of the first prediction model. For example, in a case where the first prediction model includes the third prediction model and the fourth prediction model, the global model may include a first global model and a second global model to be described later. In this case, the third prediction model is trained based on the first global model, and the fourth prediction model is trained based on the second global model.

### (Second Prediction Model)

The second prediction model is a local model trained by the information processing device 20 in order to obtain a model for predicting an effect of intervention related to a target based on a feature representing the target by the federated learning. The second prediction model may include, for example, a fifth prediction model for predicting a result in the case of presence of the intervention based on the feature, and a sixth prediction model for predicting a result in the case of absence of the intervention based on the feature. In this case, information obtained by subtracting an output of the sixth prediction model from an output of the fifth prediction model may be output from the second prediction model as the effect of the intervention.

In a case where a “status of intervention” includes only the presence or absence of the intervention, inputs of the fifth prediction model and the sixth prediction model may be only the “feature”. In a case where the “status of intervention” includes information, such as a type of the intervention or a degree of the intervention, other than the presence or absence of the intervention, the input of the fifth prediction model for predicting the result in the case of the presence of the intervention may include the status of the intervention in addition to the feature.

For example, for each of the sets of features and statuses of intervention included in the second input information, the second prediction model training unit 23 classifies the features into either the presence of the intervention or the absence of the intervention based on the statuses of intervention. As a result, the fifth prediction model is trained using a set of a feature classified as the presence of the intervention and a result predicted based on the feature as training data. In other words, the fifth prediction model is trained in such a way that the result in the case of the presence of the intervention is output when the feature is input. As described above, in the case where the status of the intervention includes information other than the presence or absence of the intervention, the fifth prediction model may be trained in such a way that the result in the case of the presence of the intervention is output when the feature and the status of the intervention are input. The sixth prediction model is trained using a set of a feature classified as the absence of the intervention and a result predicted based on the feature as training data. In other words, the sixth prediction model is trained in such a way that the result in the case of the absence of the intervention is output when the feature is input.

The second prediction model is trained based on the global model. “Being trained based on the global model” is being trained using parameters of the global model as initial parameters of the second prediction model. For example, in a case where the second prediction model includes the fifth prediction model and the sixth prediction model, the global model may include the first global model and the second global model to be described later. In this case, the fifth prediction model is trained based on the first global model, and the sixth prediction model is trained based on the second global model.

### (Global Model)

The global model is a model obtained by integrating the first prediction model and the second prediction model in order to generate, by the federated learning, a model for predicting an effect of intervention related to a target based on a feature representing the target. “Integrating models” may be, for example, integrating parameters that define the respective models. That is, the global model is defined by the integrated parameters. Integrating the parameters may be taking an average of the parameters, but is not limited thereto. In a case where the information processing system 1 includes a plurality of the information processing devices 10, the global model is a model obtained by integrating a plurality of the first prediction models and the second prediction model. In a case where the information processing system 1 includes a plurality of the information processing devices 20, the global model is a model obtained by integrating the first prediction model and a plurality of the second prediction models.

For example, the global model may include the first global model obtained by integrating the third prediction model and the fifth prediction model, and the second global model obtained by integrating the fourth prediction model and the sixth prediction model. In this case, information obtained by subtracting an output of the second global model from an output of the first global model may be output from the global model as the effect of the intervention.

Note that the global model is not limited to including the first global model and the second global model. For example, in a case where the third prediction model and the fourth prediction model are linear models, the first prediction model training unit 13 may calculate the first prediction model defined by parameters obtained by subtracting parameters of the fourth prediction model from parameters of the third prediction model. Similarly, in a case where the fifth prediction model and the sixth prediction model are linear models, the second prediction model training unit 23 may calculate the second prediction model defined by parameters obtained by subtracting parameters of the sixth prediction model from parameters of the fifth prediction model.

### (Effects of Information Processing System 1)

As described above, the information processing system 1 adopts a configuration in which the information processing devices 10 and 20 are included, the information processing device 10 includes the first acquisition unit 11, the first prediction unit 12, and the first prediction model training unit 13 described above, and the information processing device 20 includes the second acquisition unit 21, the second prediction unit 22, and the second prediction model training unit 23 described above.

Therefore, according to the information processing system 1, the information processing device 10 can obtain the prediction model (the first prediction model or the global model) that predicts an effect of intervention related to a target from a feature representing the target without needing to know a status of the intervention related to the target that cannot be acquired by the own device and without disclosing a result related to the target acquired by the own device to the information processing device 20. The information processing device 20 can obtain the prediction model (the second prediction model or the global model) that predicts an effect of intervention related to a target from a feature representing the target without needing to know a result related to the target that cannot be acquired by the own device and without disclosing a status of the intervention related to the target acquired by the own device to the information processing device 10. As a result, according to the information processing system 1, it is possible to obtain an effect that an effect of intervention can be predicted from a feature representing a target when a status of the intervention related to the target and a result obtained for the target cannot be acquired in association with each other.

### (Flow of Information Processing Method S1)

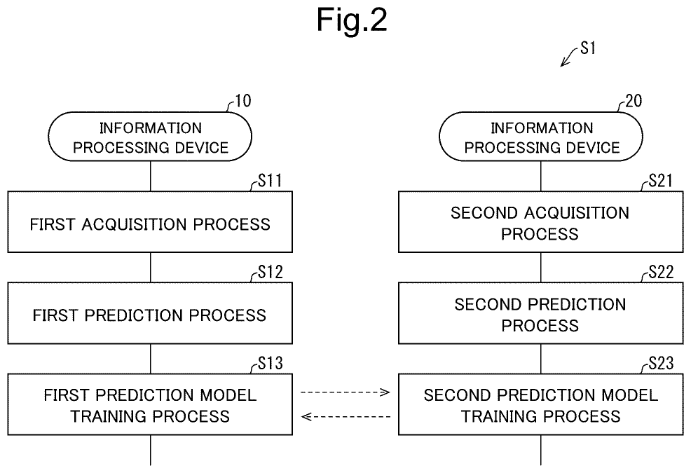

A flow of an information processing method S1 will be described with reference to FIG. 2. For example, in a case where each of the information processing devices 10 and 20 described above includes at least one processor, the information processing system 1 executes the information processing method S1. FIG. 2 is a flowchart illustrating the flow of the information processing method S1. As illustrated in FIG. 2, the information processing method S1 includes a first acquisition process S11, a first prediction process S12, a first prediction model training process S13, a second acquisition process S21, a second prediction process S22, and a second prediction model training process S23.

In the first acquisition process S11, at least one processor (for example, the first acquisition unit 11) included in the information processing device 10 acquires a feature representing a target and a result obtained for the target. In other words, first input information is acquired.

In the first prediction process S12, at least one processor (for example, the first prediction unit 12) included in the information processing device 10 predicts, based on the feature representing the target included in the first input information, a status of intervention that is likely to have affected the result related to the target.

In the first prediction model training process S13, at least one processor (for example, the first prediction model training unit 13) included in the information processing device 10 trains a prediction model for predicting an effect of the intervention by federated learning performed by the information processing devices 10 and 20 based on the feature, the result, and the status of the intervention. For example, the at least one processor trains, by machine learning, a first prediction model for predicting an effect of intervention related to a target based on a feature representing the target using the first input information and the predicted status of the intervention as training data with reference to an integrated model of the first prediction model and a second prediction model trained by the information processing device 20.

In the second acquisition process S21, at least one processor (for example, the second acquisition unit 21) included in the information processing device 20 acquires a feature representing a target and a status of intervention related to the target. In other words, second input information is acquired.

In the second prediction process S22, at least one processor (for example, the second prediction unit 22) included in the information processing device 20 predicts a result related to the target based on the feature representing the target included in the second input information.

In the second prediction model training process S23, at least one processor (for example, the second prediction model training unit 23) included in the information processing device 20 trains a prediction model for predicting an effect of the intervention by the federated learning performed by the information processing devices 10 and 20 based on the feature, the result, and the status of the intervention. For example, the at least one processor trains, by machine learning, the second prediction model for predicting an effect of intervention related to a target based on a feature representing the target using the second input information and the predicted result as training data with reference to the integrated model of the second prediction model and the first prediction model trained by the information processing device 10.

The information processing device 10 repeatedly executes at least the first prediction model training process S13. For example, the information processing device 10 may repeat a series of processes including the first prediction process S12 and the first prediction model training process S13, or may repeat the first prediction model training process S13 without repeating the first prediction process S12. The information processing device 20 repeatedly executes at least the second prediction model training process S23. For example, the information processing device 20 may repeat a series of processes including the second prediction process S22 and the second prediction model training process S23, or may repeat the second prediction model training process S23 without repeating the second prediction process S22.

In the first prediction model training process S13 and the second prediction model training process S23, a model, obtained by integrating the first prediction model and the second prediction model after training in the previous processes S13 and S23, respectively, is referred to as a new global model. In the processes S13 and S23, the same new global model is referred to, and training of the first prediction model and training of the second prediction model are performed. Note that the same initial global model is referred to in the first prediction model training process S13 executed for the first time and the second prediction model training process S23 executed for the first time.

Note that a process of integrating the first prediction model and the second prediction model to generate a new global model may be performed by any one of the information processing device 10 and the information processing device 20. For example, in a case where the information processing device 10 performs the process, the information processing device 10 may integrate the trained first prediction model in the own device and the trained second prediction model received from the information processing device 20 to generate a new global model. The information processing device 10 may transmit the new global model to the information processing device 20. In a case where the information processing device 20 performs the process, the same description will be given by replacing the information processing devices 10 and 20 with each other and replacing the first prediction model and the second prediction model with each other in the above description of the case where the information processing device 10 performs the process.

In addition, the process of integrating the first prediction model and the second prediction model to generate a new global model may be performed by a server (not illustrated) different from any of the information processing devices 10 and 20. In this case, the server may integrate the trained first prediction model received from the information processing device 10 and the trained second prediction model received from the information processing device 20 to generate a new global model, and transmit the new global model to the information processing devices 10 and 20.

As described above, (i) training the first prediction model by the information processing device 10 with reference to the global model and training the second prediction model by the information processing device 20 with reference to the global model, and (ii) using an integrated model of the first prediction model and the second prediction model as a new global model are repeated. The repetition may be performed a predetermined number of times, for example, or may be performed until the first prediction model, the second prediction model, or the global model with predetermined accuracy is obtained.

### (Effects of Information Processing Method S1)

As described above, the information processing method S1 adopts a configuration including the first acquisition process S11, the first prediction process S12, the first prediction model training process S13, the second acquisition process S21, the second prediction process S22, and the second prediction model training process S23 described above.

Therefore, according to the information processing method S1, the same effects as those of the information processing system 1 can be obtained.

### (Configuration of Information Processing Device 10)

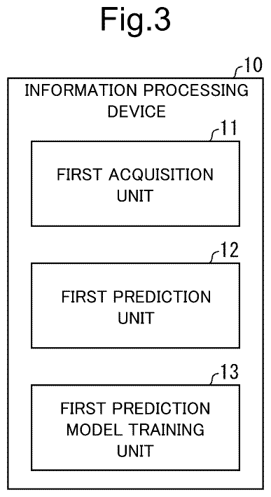

FIG. 3 is a block diagram illustrating a configuration of the information processing device 10. The information processing device 10 is an example of a configuration for implementing an information processing device according to an exemplary aspect of the present disclosure. As illustrated in FIG. 3, the information processing device 10 includes the first acquisition unit 11, the first prediction unit 12, and the first prediction model training unit 13. The first acquisition unit 11 is an example of a configuration for achieving an acquisition means. The first prediction unit 12 is an example of a configuration for achieving a prediction means. The first prediction model training unit 13 is an example of a configuration for achieving a prediction model training means. Since details of the first acquisition unit 11, the first prediction unit 12, and the first prediction model training unit 13 are as described above, the description thereof will not be repeated.

### (Effects of Information Processing Device 10)

As described above, the information processing device 10 adopts a configuration including the first acquisition unit 11, the first prediction unit 12, and the first prediction model training unit 13 described above. Therefore, according to the information processing device 10, it is possible to obtain the first prediction model (or the global model) that predicts an effect of intervention related to a target from a feature representing the target without needing to know a status of the intervention related to the target that cannot be acquired by the own device and without externally disclosing a result related to the target acquired by the own device. As a result, according to the information processing device 10, it is possible to obtain an effect that an effect of intervention can be predicted from a feature representing a target when a status of the intervention related to the target and a result obtained for the target cannot be acquired in association with each other.

### (Flow of Information Processing Method S10)

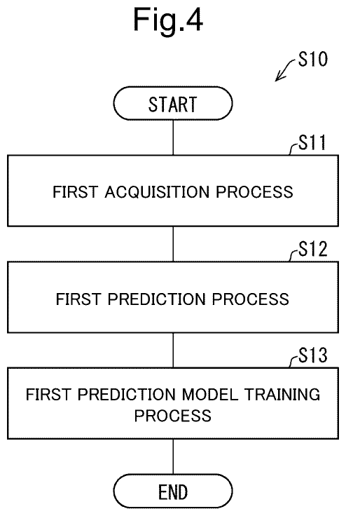

A flow of an information processing method S10 will be described with reference to FIG. 4. For example, in a case where the information processing device 10 described above includes at least one processor, the information processing device 10 executes the information processing method S10. FIG. 4 is a flowchart illustrating the flow of the information processing method S10. As illustrated in FIG. 4, the information processing method S10 includes the first acquisition process S11 (an example of an acquisition process), the first prediction process S12 (an example of a prediction process), and the first prediction model training process S13 (an example of a prediction model training process). Since details of the first acquisition process S11, the first prediction process S12, and the first prediction model training process S13 are as described above, the description thereof will not be repeated.

The at least one processor repeatedly executes at least the first prediction model training process S13. For example, the at least one processor may repeat a series of processes including the first prediction process S12 and the first prediction model training process S13, or may repeat the first prediction model training process S13 without repeating the first prediction process S12.

### (Effects of Information Processing Method S10)

As described above, the information processing method S10 adopts a configuration including the first acquisition process S11, the first prediction process S12, and the first prediction model training process S13 described above. Therefore, according to the information processing method S10, the same effects as those of the information processing device 10 can be obtained.

### (Configuration of Information Processing Device 20)

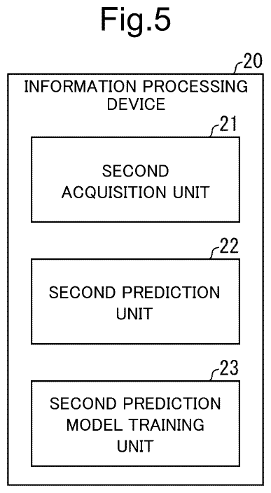

FIG. 5 is a block diagram illustrating a configuration of the information processing device 20. The information processing device 20 is an example of a configuration for achieving an information processing device according to an exemplary aspect of the present disclosure. As illustrated in FIG. 5, the information processing device 20 includes the second acquisition unit 21, the second prediction unit 22, and the second prediction model training unit 23. The second acquisition unit 21 is an example of a configuration for achieving an acquisition means. The second prediction unit 22 is an example of a configuration for achieving a prediction means. The second prediction model training unit 23 is an example of a configuration for achieving a prediction model training means. Since details of the second acquisition unit 21, the second prediction unit 22, and the second prediction model training unit 23 are as described above, the description thereof will not be repeated.

### (Effects of Information Processing Device 20)

As described above, the information processing device 20 adopts a configuration including the second acquisition unit 21, the second prediction unit 22, and the second prediction model training unit 23 described above. Therefore, according to the information processing device 20, it is possible to obtain the second prediction model (or the global model) that predicts an effect of intervention related to a target from a feature representing the target without needing to know a result obtained for the target that cannot be acquired by the own device and without externally disclosing a status of the intervention related to the target acquired by the own device. As a result, according to the information processing device 20, it is possible to obtain an effect that an effect of intervention can be predicted from a feature representing a target when a status of the intervention related to the target and a result obtained for the target cannot be acquired in association with each other.

### (Flow of Information Processing Method S20)

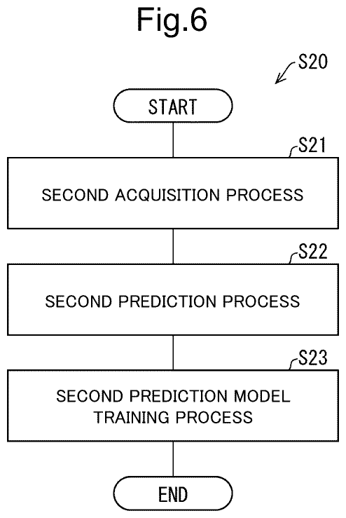

A flow of an information processing method S20 will be described with reference to FIG. 6. For example, in a case where the information processing device 20 described above includes at least one processor, the information processing device 20 executes the information processing method S20. FIG. 6 is a flowchart illustrating the flow of the information processing method S20. As illustrated in FIG. 6, the information processing method S20 includes the second acquisition process S21 (an example of an acquisition process), second prediction process S22 (an example of a prediction process), and the second prediction model training process S23 (an example of a prediction model training process). Since details of the second acquisition process S21, the second prediction process S22, and the second prediction model training process S23 are as described above, the description thereof will not be repeated.

The at least one processor repeatedly executes at least the second prediction model training process S23. For example, the at least one processor may repeat a series of processes including the second prediction process S22 and the second prediction model training process S23, or may repeat the second prediction model training process S23 without repeating the second prediction process S22.

### (Effects of Information Processing Method S20)

As described above, the information processing method S20 adopts a configuration including the second acquisition process S21, the second prediction process S22, and the second prediction model training process S23 described above. Therefore, according to the information processing method S20, the same effects as those of the information processing device 20 can be obtained.

### Second Example Embodiment

A second example embodiment that is an example of an example embodiment of the present disclosure will be described in detail with reference to the drawings. Components having the same functions as the components described in the above-described example embodiments are denoted by the same reference signs, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for description of the present example embodiment can be adopted in the other example embodiments included in the present disclosure within a range in which no particular technical problem occurs.

### (Outline of Information Processing System 1A)

An information processing system 1A is configured as follows in addition to the same configuration as the information processing system 1. In the information processing system 1A, a result prediction model trained by an information processing device 10A capable of acquiring a result related to a target and an intervention prediction model trained by an information processing device 20A capable of acquiring a status of intervention related to the target are exchanged between the information processing devices 10A and 20A.

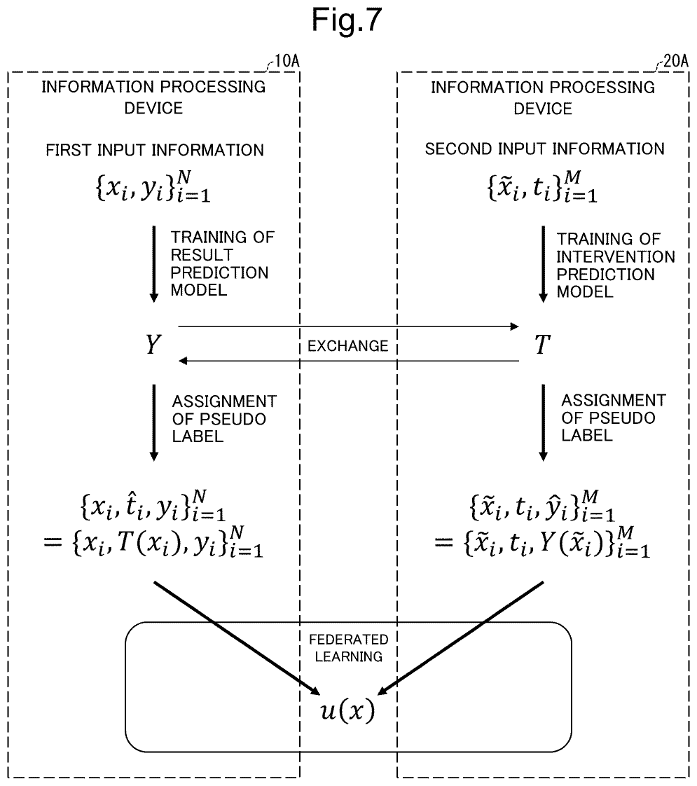

FIG. 7 is a view schematically illustrating an outline of the information processing system 1A. Hereinafter, a subscript (for example, i) illustrated in FIG. 7 is described as “_i” or the like by adding an underline to the subscript. In addition, the tilde symbol (˜) over a letter (for example, x) is described as “x˜” or the like by the tilde symbol following the letter. In addition, the hat symbol (\hat{ }) over a letter (for example, t) is described as “t\hat{ }” or the like by the hat symbol following the letter.

In FIG. 7, the information processing device 10A is a device capable of acquiring a result y_i related to a target. N sets (N is a natural number equal to or larger than two, i=1, 2, . . . , and N) each including a feature x_i representing the target and the result y_i related to the target are input to the information processing device 10A as first input information. The information processing device 10A trains a result prediction model “Y” in such a way that y_i is output when x_i is input using the first input information as training data.

The information processing device 20A is a device capable of acquiring a status t_i of intervention related to a target. M sets (M is a natural number equal to or larger than two) each including a feature x˜_i representing the target and the status t_i of intervention related to the target are input to the information processing device 20A as second input information. Note that x˜_i and x_i are common features (for example, gender and age, or the like), but are pieces of information that are not disclosed to each other, and are not necessarily features related to the same target (for example, the same user). The information processing device 20A trains an intervention prediction model “T” in such a way that t_i is output when x˜_i is input using the second input information as training data. The result prediction model “Y” and the intervention prediction model “T” are exchanged between the information processing devices 10A and 20A.

The information processing device 10A calculates “T(x_i)” using the intervention prediction model “T” obtained by the exchange, and assigns a pseudo label “t\hat{ }_i” indicating the status of intervention to the first input information.

As a result, N sets each including a triplet of the feature x_i representing the target, the pseudo label t\hat{ }_i, and the result y_i are obtained.

The information processing device 20A calculates “Y (x˜_i)” using the result prediction model “Y” obtained by the exchange, and assigns a pseudo label “y\hat{ }_i” indicating the result to the second input information. As a result, M sets each including a triplet of the feature x˜_i representing the target, the status t\hat{ }_i of the intervention, and the pseudo label y\hat{ }_i indicating the result are obtained.

Each of the information processing devices 10A and 20A can use the triplets as training data, and as a result, can generate a prediction model “u(x)” by federated learning. The prediction model u(x) is a model that outputs an effect “u(x)” of intervention using a feature “x” representing a target as an input.

### (Configuration of Information Processing System 1A)

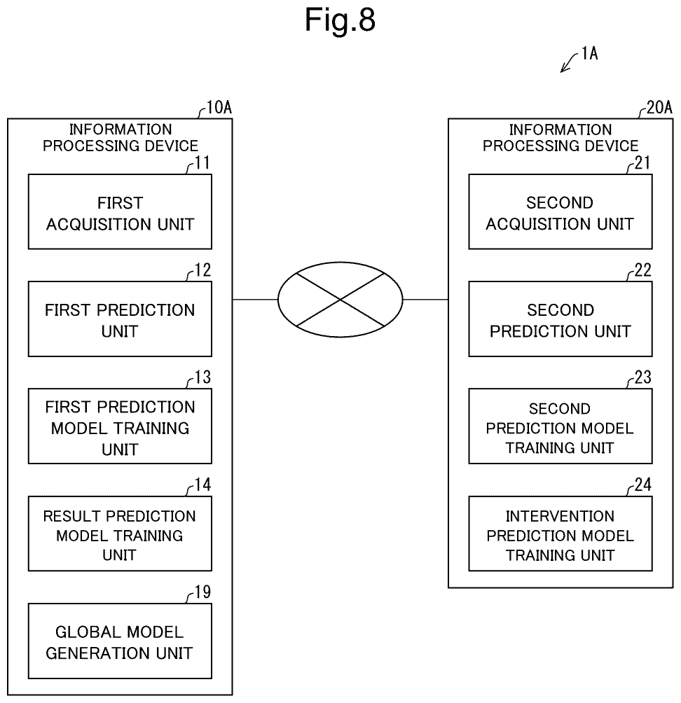

A configuration of the information processing system 1A will be described with reference to FIG. 8. FIG. 8 is a block diagram illustrating the configuration of the information processing system 1A. The information processing system 1A includes the information processing devices 10A and 20A. The information processing device 10A includes a result prediction model training unit 14 and a global model generation unit 19 in addition to the first acquisition unit 11, the first prediction unit 12, and the first prediction model training unit 13 included in the information processing device 10. The information processing device 20A includes an intervention prediction model training unit 24 in addition to the second acquisition unit 21, the second prediction unit 22, and the second prediction model training unit 23 included in the information processing device 20. The result prediction model training unit 14 is an example of a configuration for achieving a result prediction model training means. The intervention prediction model training unit 24 is an example of a configuration for achieving an intervention prediction model training means.

The result prediction model training unit 14 trains the result prediction model for predicting a result related to a target from a feature representing the target. For example, the result prediction model training unit 14 trains, by machine learning, the result prediction model for predicting a result related to a target based on a feature representing the target using the first input information as training data. In other words, the result prediction model is trained in such a way that the result included in the first input information is output when the feature included in the first input information is input.

The result prediction model training unit 14 provides the result prediction model to the information processing device 20A.

The intervention prediction model training unit 24 trains the intervention prediction model for predicting a status of intervention related to a target from a feature representing the target. For example, the intervention prediction model training unit 24 trains, by machine learning, the intervention prediction model for predicting a status of intervention related to a target based on a feature representing the target using the second input information as training data. In other words, the intervention prediction model is trained in such a way that the status of the intervention included in the second input information is output when the feature included in the second input information is input. The intervention prediction model training unit 24 provides the intervention prediction model to the information processing device 10A.

The first prediction unit 12 is configured as follows in addition to the same configuration as the first prediction unit 12 included in the information processing device 10. The first prediction unit 12 predicts a status of intervention related to a target using the intervention prediction model provided from the information processing device 20A. For example, the first prediction unit 12 inputs features representing a plurality of targets included in the first input information to the intervention prediction model and acquires statuses of intervention output from the intervention prediction model.

The second prediction unit 22 is configured as follows in addition to the same configuration as the second prediction unit 22 included in the information processing device 20. The second prediction unit 22 predicts a result related to a target using the result prediction model provided from the information processing device 10A. For example, the second prediction unit 22 inputs features representing a plurality of targets included in the second input information to the result prediction model and acquires results output from the result prediction model.

Here, training of the result prediction model is performed independently of training of a prediction model. In other words, the training of the result prediction model performed in the information processing device 10A is performed independently of training of a first prediction model that is a local model in the federated learning for generating the prediction model. As a result, for example, the training of the result prediction model can be completed before the start of the training of the first prediction model. The result prediction model for which the training has been completed can be provided to the information processing device 20A before the start of training of a second prediction model. As a result, before the start of the training of the second prediction model, the information processing device 20A can accurately predict a “result” necessary for the training using the result prediction model for which the training has been completed.

Training of the intervention prediction model is performed independently of training of a prediction model. In other words, the training of the intervention prediction model performed in the information processing device 20A is performed independently of the training of the second prediction model that is a local model in the federated learning for generating the prediction model. As a result, for example, the training of the intervention prediction model can be completed before the start of the training of the second prediction model. The intervention prediction model for which the training has been completed can be provided to the information processing device 10A before the start of training of the first prediction model. As a result, before the start of the training of the first prediction model, the information processing device 10A can accurately predict a “status of intervention” necessary for the training using the intervention prediction model for which the training has been completed.

The global model generation unit 19 generates an initial global model and provides the initial global model to the first prediction model training unit 13 and the second prediction model training unit 23. The initial global model is defined by initial parameters. The global model generation unit 19 generates a new global model obtained by integrating the first prediction model and the second prediction model, and provides the new global model to the first prediction model training unit 13 and the second prediction model training unit 23.

### (Flow of Information Processing Method S1A)

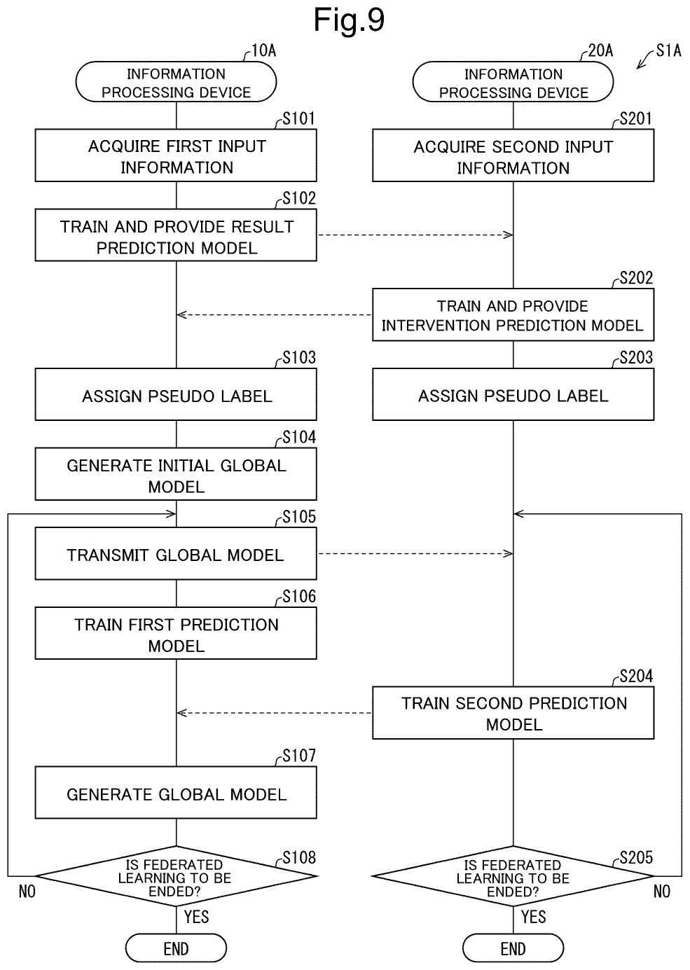

A flow of an information processing method SIA will be described with reference to FIG. 9. For example, in a case where each of the information processing devices 10A and 20A described above includes at least one processor, the information processing system 1A executes the information processing method SIA. FIG. 9 is a flowchart illustrating the flow of the information processing method SIA. As illustrated in FIG. 9, the information processing method SIA includes steps S101 to S108 executed by the information processing device 10A and steps S201 to S205 executed by the information processing device 20A.

In step S101, the first acquisition unit 11 acquires first input information including a feature representing a target and a result related to the target. Step S101 is an example of a first acquisition process.

In step S201, the second acquisition unit 21 acquires second input information including a feature representing a target and a status of intervention related to the target. Step S201 is an example of a second acquisition process. The execution order of steps S101 and S201 is not limited to this order, and there is no particular order. The expression that “there is no particular order for the execution order of a plurality of steps” includes executing the steps in any order, executing some or all of the steps in parallel, and the like.

In step S102, the result prediction model training unit 14 trains the result prediction model using the first input information as training data. The result prediction model training unit 14 transmits the trained result prediction model to the information processing device 20A. Step S102 is an example of a result prediction model training process.

In step S202, the intervention prediction model training unit 24 trains the intervention prediction model using the second input information as training data. The intervention prediction model training unit 24 transmits the trained intervention prediction model to the information processing device 10A. Step S202 is an example of an intervention prediction model training process. The execution order of steps S102 and S202 is not limited to this order, and there is no particular order.

In step S103, using the intervention prediction model received from the information processing device 20A in step S202, the first prediction unit 12 predicts a status of intervention related to a target based on the feature representing the target included in the first input information. As a result, a pseudo label indicating the predicted status of the intervention is assigned to the feature representing each of a plurality of the targets included in the first input information. Step S103 is an example of a first prediction process.

In step S203, the second prediction unit 22 predicts a result related to a target based on the feature representing the target included in the second input information using the result prediction model received from the information processing device 10A in step S102. As a result, a pseudo label indicating the predicted result is assigned to the feature representing each of a plurality of the targets included in the second input information.

Step S203 is an example of a second prediction process. The execution order of steps S103 and S203 is not limited to this order, and there is no particular order.

In step S104, the global model generation unit 19 generates an initial global model. In other words, the global model generation unit 19 sets initial parameters that define the global model. Step S104 may be executed before step S105 is executed, and is not necessarily executed after step S103.

In step S105, the global model generation unit 19 transmits the global model to the information processing device 20A.

In step S106, the first prediction model training unit 13 trains the first prediction model with reference to the global model using the first input information and the pseudo label indicating the status of the intervention as training data. Step S106 is an example of a first prediction model training process. Since details of the training of the first prediction model are as described in the first example embodiment, the description thereof will not be repeated.

In step S204, the second prediction model training unit 23 trains the second prediction model with reference to the global model using the second input information and the pseudo label indicating the result as training data. Step S204 is an example of a second prediction model training process. Since details of the training of the second prediction model are as described in the first example embodiment, the description thereof will not be repeated.

The second prediction model training unit 23 transmits the trained second prediction model to the information processing device 10A. The execution order of steps S106 and S204 is not limited to this order, and there is no particular order.

In step S107, the global model generation unit 19 generates a new global model obtained by integrating the first prediction model after training in step S106 and the second prediction model received from the information processing device 20A in step S204.

In step S108, the information processing device 10A determines whether to end the federated learning. In a case where it is determined not to end the federated learning, the information processing device 10A repeats the processes from step S105. The information processing device 10A may determine whether to end the federated learning based on whether the number of repetitions has reached a predetermined number of times, or based on whether the accuracy of the first prediction model (or the global model) has exceeded a threshold. However, a viewpoint of determining whether to end the federated learning is not limited to these examples.

The global model transmitted to the information processing device 20A in the next step S105 is the new global model generated in step S107 and obtained by integrating the first prediction model and the second prediction model. In the next step S106, the first prediction model is trained with reference to the “new global model obtained by integrating the first prediction model and the second prediction model”. In each repeated step S106 (first prediction model training process), the pseudo label indicating the status of the intervention assigned in advance in step S103 is referred to.

In step S205, the information processing device 20A determines whether to end the federated learning. In a case where it is determined not to end the federated learning, the information processing device 20A repeats the processes from step S204. The information processing device 20A may determine whether to end the federated learning based on whether the number of repetitions has reached a predetermined number of times, or based on whether the accuracy of the second prediction model (or the global model) has exceeded a threshold. However, a viewpoint of determining whether to end the federated learning is not limited to these examples.

In the next step S204, the second prediction model is trained with reference to the “new global model obtained by integrating the first prediction model and the second prediction model” received from the information processing device 10A. In each repeated step S204 (second prediction model training process), the pseudo label indicating the result assigned in advance in step S203 is referred to.

In a case where it is determined in step S108 or S205 to end the federated learning, the information processing method SIA ends. As a result, the information processing device 10A can obtain the first prediction model or the global model for predicting an effect of intervention related to a target based on a feature representing the target. The information processing device 20A can obtain the second prediction model or the global model for predicting an effect of intervention related to a target based on a feature representing the target.

### (Effects of Present Example Embodiment)

As described above, the information processing system 1A adopts a configuration in which the information processing device 10A further includes the result prediction model training unit 14 that trains the result prediction model for predicting a result related to a target from a feature representing the target, the information processing device 20A further includes the intervention prediction model training unit 24 that trains the intervention prediction model for predicting a status of intervention related to a target based on a feature representing the target, the first prediction unit 12 predicts a status of intervention related to the target using the intervention prediction model, and the second prediction unit 22 predicts a result related to the target using the result prediction model. Therefore, according to the information processing system 1A, in addition to the effects achieved by the information processing system 1, the information processing device 10A that cannot acquire a status of intervention related to the target can accurately predict the status of the intervention using the intervention prediction model trained by the information processing device 20A that can acquire the status of the intervention. The information processing device 20A that cannot acquire a result related to the target can accurately predict the result using the result prediction model trained by the information processing device 10A that can acquire the result.

The information processing system 1A adopts a configuration in which training of the result prediction model is performed independently of training of a prediction model, and training of the intervention prediction model is performed independently of training of a prediction model. Therefore, according to the information processing system 1A, in addition to the effects achieved by the information processing system 1, the federated learning for generating a prediction model (the first prediction model, the second prediction model, or the global model) that predicts an effect of intervention related to a target based on a feature representing the target can be started using, as training data, a status of the intervention and a result accurately predicted by the result prediction model and the intervention prediction model for which the training has been completed, and as a result, an effect that convergence is fast can be obtained.

### (First Modified Example)

The information processing system 1A described above can be modified as follows. A prediction model and a result prediction model have a common former part. In other words, a first prediction model, which is a local model in federated learning for generating the prediction model, and the result prediction model have the common former part. In addition, a prediction model and an intervention prediction model have a common former part. In other words, a second prediction model, which is a local model in the federated learning for generating the prediction model, and the intervention prediction model have the common former part.

For example, the first prediction model training unit 13 may set a former part of a trained result prediction model as a former part of the first prediction model, and train a latter part of the first prediction model by the federated learning.

For example, in a case where the first prediction model and the result prediction model are configured using a neural network, a predetermined number of layers from the input side among a plurality of layers constituting the trained result prediction model may be used as the former part. In addition, for example, the second prediction model training unit 23 may set a former part of a trained intervention prediction model as a former part of the second prediction model, and train a latter part of the second prediction model by the federated learning. For example, in a case where the second prediction model and the intervention prediction model are configured using a neural network, a predetermined number of layers from the input side among a plurality of layers constituting the trained intervention prediction model may be used as the former part. Note that an output from the former part shared by the first prediction model and the result prediction model and an output from the former part shared by the second prediction model and the intervention prediction model desirably have at least the same number of dimensions.

In the present modified example, for example, the information processing method S1A illustrated in FIG. 9 is modified as follows.

In step S104, the global model generation unit 19 generates an initial global model corresponding to the latter part of the first prediction model.

In step S106, the first prediction model training unit 13 sets the former part of the result prediction model as the former part of the first prediction model and trains the latter part of the first prediction model, instead of training the entire first prediction model.

In step S204, the second prediction model training unit 23 sets the former part of the intervention prediction model as the former part of the second prediction model, and trains the latter part of the second prediction model, instead of training the entire second prediction model.

In step S107, the global model generation unit 19 generates a global model obtained by integrating the latter part of the first prediction model and the latter part of the second prediction model.

### (Effects of Present Modified Example)

In the present modified example, the first prediction model and the result prediction model have the common former part, and the second prediction model and the intervention prediction model have the common former part. As a result, since a model that needs to be repeatedly trained by the federated learning serves as the latter part of each of the first prediction model and the second prediction model, calculation cost can be reduced.

### [Second Modified Example]

The first modified example of the information processing system 1A described above can be further modified as follows. The first prediction model training unit 13 and the result prediction model training unit 14 train a prediction model and a result prediction model in parallel while sharing a common former part. In other words, the first prediction model training unit 13 and the result prediction model training unit 14 train a first prediction model, which is a local model in federated learning for generating the prediction model, and the result prediction model in parallel while sharing the common former part. The second prediction model training unit 23 and the intervention prediction model training unit 24 train a prediction model and an intervention prediction model in parallel while sharing a common former part. In other words, the second prediction model training unit 23 and the intervention prediction model training unit 24 train a second prediction model, which is a local model in the federated learning for generating the prediction model, and the intervention prediction model in parallel while sharing the common former part.

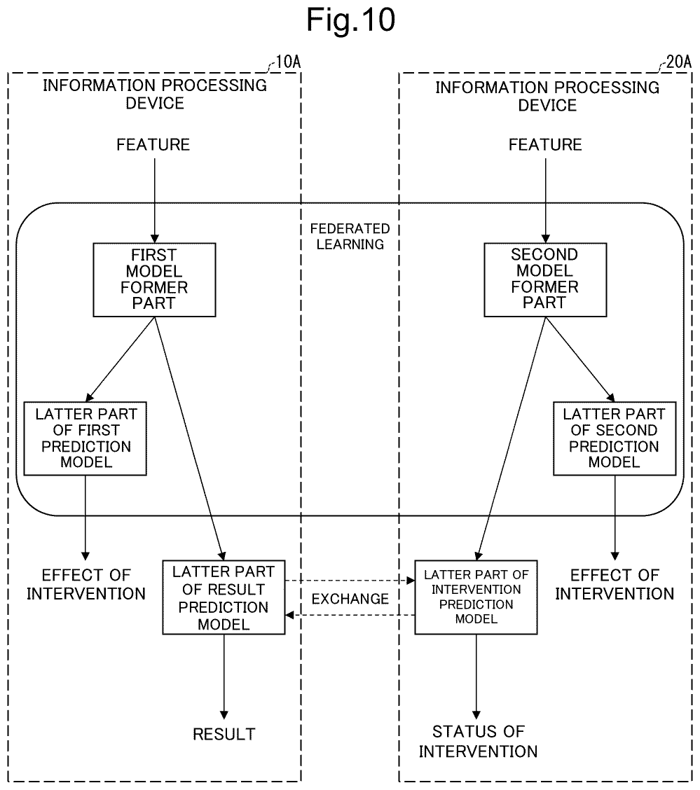

FIG. 10 is a view schematically illustrating each model according to the present modified example. As illustrated in FIG. 10, a first model former part is the former part shared by the first prediction model and the result prediction model. A feature representing a target is input to the first model former part. Am intermediate expression output from the first model former part is input to a latter part of the first prediction model and a latter part of the result prediction model. An effect of intervention is output from the latter part of the first prediction model. A result is output from the latter part of the result prediction model.

As illustrated in FIG. 10, a second model former part is the former part shared by the second prediction model and the intervention prediction model. A feature representing a target is input to the second model former part. An intermediate expression output from the second model former part is input to a latter part of the second prediction model and a latter part of the intervention prediction model. An effect of intervention is output from the latter part of the second prediction model. A status of the intervention is output from the latter part of the intervention prediction model.

Here, the first prediction model including the first model former part and the latter part of the first prediction model and the second prediction model including the second model former part and the latter part of the second prediction model are trained by the federated learning. The latter part of the result prediction model and the latter part of the intervention prediction model are independently trained in the information processing devices 10A and 20A, respectively, and exchanged.

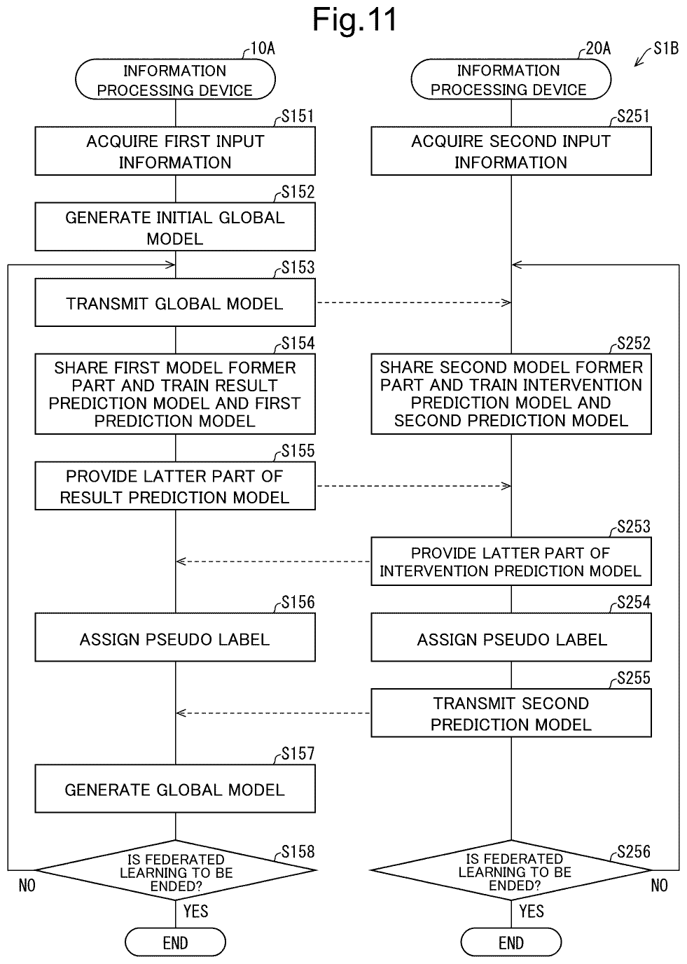

In the present modified example, an information processing method S1B is executed instead of the information processing method SIA illustrated in FIG. 9. FIG. 11 is a flowchart illustrating a flow of the information processing method S1B. As illustrated in FIG. 11, the information processing method SIB includes steps S151 to S158 executed by the information processing device 10A and steps S251 to S256 executed by the information processing device 20A.

In step S151, the first acquisition unit 11 acquires first input information. Step S151 is similar to step S101 described above.

In step S251, the second acquisition unit 21 acquires second input information. Step S251 is similar to step S201 described above. The execution order of steps S151 and S251 is not limited to this order, and there is no particular order.

In step S152, the global model generation unit 19 generates an initial global model. Step S152 is similar to step S104 described above. Step S152 may be executed before step S153 is executed, and is not necessarily executed after step S151.

In step S153, the global model generation unit 19 transmits the global model to the information processing device 20A. Step S153 is similar to step S105 described above.

In step S154, the first prediction model training unit 13 and the result prediction model training unit 14 of the information processing device 10A train the first prediction model and the result prediction model in parallel with the common first model former part using the first input information and a pseudo label indicating a status of intervention as training data. In other words, the former part of the first prediction model, the latter part of the first prediction model, and the latter part of the result prediction model are trained in parallel. For such a parallel training process, a known multi-task learning method can be adopted.

In the training performed in parallel in step S154, the training of the first prediction model is performed with reference to the global model. That is, the training is performed by setting parameters of a former part and a latter part of the global model as initial parameters of the former part of the first prediction model and the latter part of the first prediction model.

In addition, in the training performed in parallel in step S154, a pseudo label indicating a status of intervention is required for the training of the first prediction model, but the intervention prediction model required to assign the pseudo label has not yet been obtained when step S154 is executed for the first time. In this case, the pseudo label may be assigned using any intervention prediction model. Pseudo labels in a case where step S154 is executed for the second and subsequent times will be described later. In step S154 executed for the first time, the training of the first prediction model may be omitted, and only the training of the result prediction model may be performed.

In step S252, the second prediction model training unit 23 and the intervention prediction model training unit 24 of the information processing device 20A train the second prediction model and the intervention prediction model in parallel with the common second model former part using the second input information and a pseudo label indicating a result as training data. In other words, the former part of the second prediction model, the latter part of the second prediction model, and the latter part of the intervention prediction model are trained in parallel. For such a parallel training process, a known multi-task learning method can be adopted.

In the training performed in parallel in step S252, the training of the second prediction model is performed with reference to the global model. That is, the training is performed by setting parameters of the former part and the latter part of the global model as initial parameters of the former part of the second prediction model and the latter part of the second prediction model.

In addition, in the training performed in parallel in step S252, a pseudo label indicating a result is required for the training of the second prediction model, but the result prediction model required to assign the pseudo label has not yet been obtained when step S252 is executed for the first time. In this case, the pseudo label may be assigned using any result prediction model. Pseudo labels in a case where step S252 is executed for the second and subsequent times will be described later.

In step S252 executed for the first time, the training of the second prediction model may be omitted, and only the training of the intervention prediction model may be performed. The execution order of steps S154 and S252 is not limited to this order, and there is no particular order.

In step S155, the result prediction model training unit 14 of the information processing device 10A transmits a latter part of the trained result prediction model to the information processing device 20A.

In step S253, the intervention prediction model training unit 24 of the information processing device 20A transmits a latter part of the trained intervention prediction model to the information processing device 10A. The execution order of steps S155 and S253 is not limited to this order, and there is no particular order.

In step S156, the first prediction unit 12 of the information processing device 10A assigns a pseudo label indicating a status of intervention to the feature representing each of a plurality of the targets included in the first input information using the trained first model former part and the received latter part of the intervention prediction model. The pseudo label assigned in this step is referred to when the first prediction model and the result prediction model are trained in parallel in the next step S154.

In step S254, the second prediction unit 22 of the information processing device 20A assigns a pseudo label indicating a result to the feature representing each of a plurality of the targets included in the second input information using the trained second model former part and the received latter part of the result prediction model. The pseudo label assigned in this step is referred to when the second prediction model and the intervention prediction model are trained in parallel in the next step S252. The execution order of steps S156 and S254 is not limited to this order, and there is no particular order.

In step S255, the second prediction model training unit 23 of the information processing device 20A transmits the second prediction model including the second model former part and the latter part of the second prediction model to the information processing device 10A.

In step S157, the global model generation unit 19 generates a new global model obtained by integrating the first prediction model including the first model former part and the latter part of the first prediction model and the received second prediction model.

In step S158, the information processing device 10A determines whether to end the federated learning. Since a specific example of determining whether to end the federated learning is similar to step S108, the detailed description thereof will not be repeated. In a case where it is determined not to end the federated learning, the information processing device 10A repeats the processes from step S153.

The global model transmitted to the information processing device 20A in the next step S153 is the new global model generated in the previous step S157 and obtained by integrating the first prediction model and the second prediction model. In the next step S154, a former part of the new global model serves as a first model former part at the start of training. In addition, a latter part of the new global model serves as a latter part of the first prediction model at the start of training. The latter part of the result prediction model trained in the previous step S154 serves as a latter part of the result prediction model at the start of training. Then, the first model former part, the latter part of the first prediction model, and the latter part of the result prediction model are trained in parallel. In the training, the pseudo label assigned in the previous step S156 is referred to.

In step S256, the information processing device 20A determines whether to end the federated learning. Since a specific example of determining whether to end the federated learning is similar to step S205, the detailed description thereof will not be repeated. In a case where it is determined not to end the federated learning, the information processing device 20A repeats the processes from step S252.

In the next step S252, a former part of the “new global model obtained by integrating the first prediction model and the second prediction model” received from the information processing device 10A serves as a second model former part at the start of training. In addition, the latter part of the new global model serves as a latter part of the second prediction model at the start of training. The latter part of the intervention prediction model trained in the previous step S252 serves as a latter part of the intervention prediction model at the start of training. Then, the second model former part, the latter part of the second prediction model, and the latter part of the intervention prediction model are trained in parallel. In the training, the pseudo label assigned in the previous step S254 is referred to.

In a case where it is determined in step S158 or S256 to end the federated learning, the information processing method S1B ends. As a result, the information processing device 10A can obtain the first prediction model or the global model for predicting an effect of intervention related to a target based on a feature representing the target. The information processing device 20A can obtain the second prediction model or the global model for predicting an effect of intervention related to a target based on a feature representing the target.

### (Effects of Present Modified Example)

The present modified example adopts a configuration in which the first prediction model training unit 13 and the result prediction model training unit 14 train the prediction model and the result prediction model in parallel while sharing the common former part, and the second prediction model training unit 23 and the intervention prediction model training unit 24 train the prediction model and the intervention prediction model in parallel while sharing the common former part, in addition to the first modified example. As a result, it is possible to obtain an effect that the prediction model and the result prediction model are improved in performance in the information processing device 10A since knowledge can be transferred between a task of predicting an effect of intervention and a task of predicting a result. In addition, it is possible to obtain an effect that the prediction model and the intervention prediction model are improved in performance in the information processing device 20A since knowledge can be transferred between a task of predicting an effect of intervention and a task of predicting a status of the intervention. In addition, it is possible to obtain an effect that an effect of the federated learning can be reflected also in assignment of a pseudo label since the former parts of the result prediction model and the intervention prediction model are generated by the federated learning.

### [Another Modified Example]

The global model generation unit 19 may be included in the information processing device 20A instead of being included in the information processing device 10A, or may be included in a device different from any of the information processing devices 10A and 20A. Also in the present modified example, the information processing system 1A achieves the above-described effects.

### [Application Example]

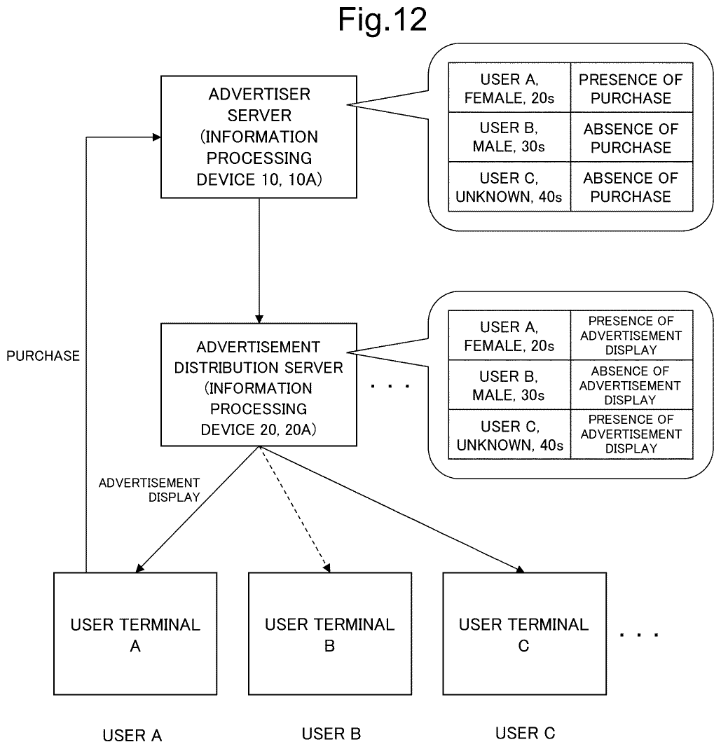

FIG. 12 is a view schematically illustrating an application example of predicting a sales promotion effect obtained by advertisement display using the information processing system 1 or 1A. For example, an advertiser requests one or a plurality of advertisement distribution platforms to distribute an advertisement in order to promote purchase of a product.

In this case, as illustrated in FIG. 12, an advertiser server managed by the advertiser can acquire gender and age (an example of a feature) of a user (A, B, C, or the like) (an example of a target) and the presence or absence of purchase by the user (an example of a result). An advertisement distribution server managed by the advertisement distribution platform can acquire the gender and age of the user and the presence or absence of advertisement display (an example of a status of intervention) on a user terminal (A, B, C, or the like) used by the user. However, the advertiser server and the advertisement distribution server cannot disclose the presence or absence of purchase by the user and the presence or absence of advertisement display for the user from a viewpoint of privacy protection or the like. For this reason, it is difficult to associate the presence or absence of advertisement display for the user and the presence or absence of purchase by the user. Therefore, the advertiser server is applied as an example of the information processing devices 10 and 10A, and the advertisement distribution server is applied as an example of the information processing devices 20 and 20A. This makes it possible to generate a prediction model for predicting an effect of the advertisement display (an example of an effect of intervention) based on the gender and age of the user.

According to the present application example, the advertiser can generate a prediction model for predicting a sales promotion effect in cooperation with the advertisement distribution platform without needing to know whether the advertisement has been displayed for a user who has purchased a product and without needing to disclose the presence or absence of purchase of the product. As a result, the advertiser can predict the sales promotion effect obtained by the advertisement display according to features of users, and can request the advertisement distribution platform to distribute the advertisement so as to preferentially distribute the advertisement to a user having a feature for which the effect is high.

In addition, according to the present application example, the advertisement distribution platform can generate a prediction model for predicting a sales promotion effect in cooperation with the advertiser without needing to know whether the product has been purchased by a user for which the advertisement of the product has been displayed and without needing to disclose the presence or absence of the advertisement display. As a result, the advertisement distribution platform can predict the sales promotion effect obtained by the advertisement display according to features of users, and can preferentially distribute the advertisement according to the effect.

As a result, for example, an increase in an incentive or the like from the advertiser can be expected.

### [Example of Implementation by Software]

Some or all of the functions of the information processing devices 10, 10A, 20, and 20A (hereinafter, also described as “each of the above devices”) constituting the information processing system 1 and 1A may be implemented by hardware such as an integrated circuit (IC chip) or may be implemented by software.

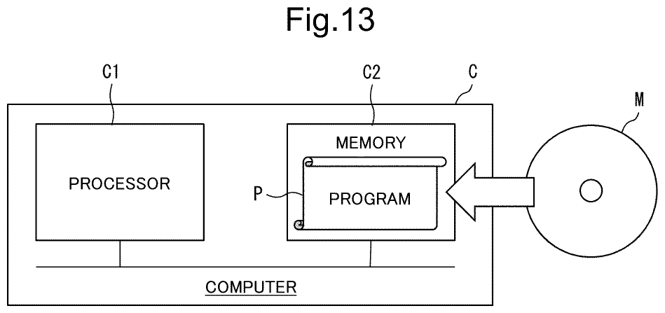

In the latter case, each of the above devices is implemented by, for example, a computer that executes a command of a program which is software for implementing each function. An example of such a computer (hereinafter described as a computer C) is illustrated in FIG. 13. FIG. 13 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented by cooperation of a plurality of processors provided in a single computer, or may be implemented by cooperation of a plurality of processors provided in a plurality of computers, respectively. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers, respectively.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

### [Supplementary Note]

The present disclosure includes the techniques described in the following supplementary notes. However, the present disclosure is not limited to the techniques described in the following supplementary notes, and various modifications can be made within the scope described in the claims.

### (Supplementary Note 1)

An information processing system including:
a first information processing device; and
a second information processing device, wherein
the first information processing device includes:
   one or more memories storing instructions; and
   one or more processors configured to execute the instructions to:
   acquire a feature representing a target and a result obtained for the target;
   predict a status of intervention that is likely to have affected the result based on the feature; and
   train a prediction model for predicting an effect of the intervention by federated learning performed by the first information processing device and the second information processing device based on the feature, the result, and the status of the intervention, and
the second information processing device includes:
   one or more memories storing instructions; and
   one or more processors configured to execute the instructions to:
   acquire the feature and the status of the intervention;
   predict the result based on the feature; and
   train the prediction model by the federated learning based on the feature, the result, and the status of the intervention.

### (Supplementary Note 2)

The information processing system according to Supplementary Note 1, wherein
the one or more processors of the first information processing device are further configured to execute the instructions to:
   train a result prediction model for predicting the result from the feature; and
   predict the status of the intervention using an intervention prediction model for predicting the status of the intervention from the feature, and
the one or more processors of the second information processing device are further configured to execute the instructions to:
   train the intervention prediction model; and
   predict the result using the result prediction model.

### (Supplementary Note 3)

The information processing system according to Supplementary Note 2, wherein
the training of the result prediction model is performed independently of the training of the prediction model, and
the training of the intervention prediction model is performed independently of the training of the prediction model.

### (Supplementary Note 4)

The information processing system according to Supplementary Note 2, wherein
the prediction model and the result prediction model have a common former part, and
the prediction model and the intervention prediction model have a common former part.

### (Supplementary Note 5)

The information processing system according to Supplementary Note 4, wherein
the one or more processors of the first information processing device are further configured to execute the instructions to train the prediction model and the result prediction model in parallel while sharing the common former part, and
the one or more processors of the second information processing device are further configured to execute the instructions to train the prediction model and the intervention prediction model in parallel while sharing the common former part.

### (Supplementary Note 6)

An information processing device including:
one or more memories storing instructions; and
one or more processors configured to execute the instructions to:
acquire a feature representing a target and a result obtained for the target;
predict a status of intervention that is likely to have affected the result based on the feature; and
train a prediction model for predicting an effect of the intervention by federated learning performed by another information processing device capable of acquiring a status of the intervention and the information processing device based on the feature, the result, and the status of the intervention.

### (Supplementary Note 7)

An information processing device including:
one or more memories storing instructions; and
one or more processors configured to execute the instructions to:
acquire a feature representing a target and a status of intervention that is likely to have affected a result obtained for the target;
predict the result based on the feature; and
train a prediction model for predicting an effect of the intervention by federated learning performed by another information processing device capable of acquiring the result and the information processing device based on the feature, the result, and the status of the intervention.

### (Supplementary Note 8)

An information processing method executed by an information processing system including a first information processing device and a second information processing device, the information processing method including:
acquiring, by at least one processor included in the first information processing device, a feature representing a target and a result obtained for the target;
predicting, by the at least one processor included in the first information processing device, a status of intervention that is likely to have affected the result based on the feature;
training, by the at least one processor included in the first information processing device, a prediction model for predicting an effect of the intervention by federated learning performed by the first information processing device and the second information processing device based on the feature, the result, and the status of the intervention;
acquiring, by at least one processor included in the second information processing device, the feature and the status of the intervention;
predicting, by the at least one processor included in the second information processing device, the result based on the feature; and
training, by the at least one processor included in the second information processing device, the prediction model by the federated learning based on the feature, the result, and the status of the intervention.

### (Supplementary Note 9)

An information processing method executed by a computer including:
acquiring, by at least one processor included in an information processing device, a feature representing a target and a result obtained for the target;
predicting, by the at least one processor, a status of intervention that is likely to have affected the result based on the feature; and
training, by the at least one processor, a prediction model for predicting an effect of the intervention by federated learning performed by another information processing device capable of acquiring the status of the intervention and the information processing device based on the feature, the result, and the status of the intervention.

### (Supplementary Note 10)

An information processing method executed by a computer including:
acquiring, by at least one processor included in an information processing device, a feature representing a target and a status of intervention that is likely to have affected a result obtained for the target;
predicting, by the at least one processor, the result based on the feature; and
training, by the at least one processor, a prediction model for predicting an effect of the intervention by federated learning performed by another information processing device capable of acquiring the result and the information processing device based on the feature, the result, and the status of the intervention.

### (Supplementary Note 11)

A non-transitory recording medium storing an information processing program causing at least one processor included in the information processing device according to Supplementary Note 6 to execute:
acquiring a feature representing a target and a result obtained for the target;
predicting a status of intervention that is likely to have affected the result based on the feature; and
training process of training a prediction model for predicting an effect of the intervention by federated learning performed by another information processing device capable of acquiring a status of the intervention and the information processing device based on the feature, the result, and the status of the intervention.

### (Supplementary Note 12)

A non-transitory recording medium storing an information processing program causing at least one processor included in the information processing device according to Supplementary Note 7 to execute:
acquiring a feature representing a target and a status of intervention that is likely to have affected a result obtained for the target;
predicting the result based on the feature; and
training a prediction model for predicting an effect of the intervention by federated learning performed by another information processing device capable of acquiring the result and the information processing device based on the feature, the result, and the status of the intervention.

1. An information processing system comprising:
a first information processing device; and
a second information processing device, wherein
the first information processing device includes:
one or more memories storing instructions; and
one or more processors configured to execute the instructions to:
acquire a feature representing a target and a result obtained for the target;
predict a status of intervention that is likely to have affected the result based on the feature; and
train a prediction model for predicting an effect of the intervention using federated learning performed by the first information processing device and the second information processing device based on the feature, the result, and the status of the intervention, and
the second information processing device includes:
one or more memories storing instructions; and
one or more processors configured to execute the instructions to:
acquire the feature and the status of the intervention;
predict the result based on the feature; and
train the prediction model by the federated learning based on the feature, the result, and the status of the intervention.

2. The information processing system according to claim 1, wherein
the one or more processors of the first information processing device are further configured to execute the instructions to:
train a result prediction model for predicting the result from the feature; and
predict the status of the intervention using an intervention prediction model for predicting the status of the intervention from the feature, and
the one or more processors of the second information processing device are further configured to execute the instructions to:
train the intervention prediction model; and
predict the result using the result prediction model.

3. The information processing system according to claim 2, wherein
the training of the result prediction model is performed independently of the training of the prediction model, and
the training of the intervention prediction model is performed independently of the training of the prediction model.

4. The information processing system according to claim 2, wherein
the prediction model and the result prediction model have a common former part, and
the prediction model and the intervention prediction model have a common former part.

5. The information processing system according to claim 4, wherein
the one or more processors of the first information processing device are further configured to execute the instructions to train the prediction model and the result prediction model in parallel while sharing the common former part, and
the one or more processors of the second information processing device are further configured to execute the instructions to train the prediction model and the intervention prediction model in parallel while sharing the common former part.

6. An information processing device comprising:
one or more memories storing instructions; and
one or more processors configured to execute the instructions to:
acquire a feature representing a target and a result obtained for the target;
predict a status of intervention that is likely to have affected the result based on the feature; and
train a prediction model for predicting an effect of the intervention using federated learning performed by another information processing device capable of acquiring a status of the intervention and the information processing device based on the feature, the result, and the status of the intervention.

7. An information processing method executed by a computer comprising:
acquiring, by at least one processor included in an information processing device, a feature representing a target and a result obtained for the target;
predicting, by the at least one processor, a status of intervention that is likely to have affected the result based on the feature; and
training, by the at least one processor, a prediction model for predicting an effect of the intervention using federated learning performed by another information processing device capable of acquiring the status of the intervention and the information processing device based on the feature, the result, and the status of the intervention.
